(19) United States
(12) Patent Application Publication
(10) Pub. No.: US 2020/0055563 A1
(43) Pub. Date: Feb. 20, 2020

(54) Barefoot Bike Pedals

(71) Applicant: Troy Edward Lindgaard Hollebeke, Redondo Beach, CA (US)

(72) Inventor: Troy Edward Lindgaard Hollebeke, Redondo Beach, CA (US)

(21) Appl. No.: 16/545,929

(22) Filed: Aug. 20, 2019

Related U.S. Application Data
(60) Provisional application No. 62/720,074, filed on Aug. 20, 2018.

(51) Int. Cl. B62M 3/08

(52) U.S. Cl. CPC B62M 3/08; B62M 3/086

(57) ABSTRACT

Described is a set of bike pedals configured for barefoot use. In one example embodiment, the pedals include a contoured and rounded platform portion, and a toe post extending generally perpendicularly from a front of the platform portion.

### RELATED APPLICATIONS

This application claims benefit of and priority to U.S. Provisional Application Ser. No. 62/720,074 filed Aug. 20, 2018 entitled Barefoot Bike Pedals, which is hereby incorporated herein by reference in its entirety.

### BACKGROUND OF THE INVENTION

Bicycles, tandem bicycles, tricycles, or similar vehicles typically include a mechanical linkage that converts the movement of two foot pedals into rotational movement of one of the wheels, propelling the vehicle forward. Several different types of pedals are popularly used with modern bikes; platform pedals, pedal toe clips/straps, and clipless bike pedals.

Platform bike pedals are generally the most popular style of pedals, providing a flat, stable surface for the bottom of the user's shoes. Many designs of platforms bike pedals include apertures through the platform to maintain a light weight and raised bumps or ridges to enhance the traction with a user's shoe. While this style pedal often functions well with most shoes, they can be difficult and uncomfortable to use while barefoot due to the apertures, bumps, and ridges.

Pedal toe clips/straps typically provide small frames attached to the front of a platform pedal, allowing the front portion of the user's foot to be partially captured. Unlike normal platform pedals, the user can both push down on the pedal and use the to clips to pull upwards. Again, the design of these pedals can be difficult and uncomfortable to use while barefoot due to the apertures, bumps, ridges, and straps.

Clipless bike pedals provide a direct connection mechanism between the pedal and structures on the user's shoes. While these style pedals are thought to be the most efficient and provide the most control, they require that the user wears specific shoes with the connection mechanism. Additionally, the pedals are often only sized to include the cleat-like connection mechanism and not to provide any further food support to the user, preventing use of the pedal when barefoot.

### SUMMARY OF THE INVENTION

One embodiment of the present invention is directed to a set of bike pedals configured for barefoot use. In one example embodiment, the pedals include a contoured and rounded platform portion, and a toe post extending generally perpendicularly from a front of the platform portion.

In one embodiment, the bottom surface of the platform portion also includes a clipless mechanism to connect to clipless bike shoes. In another embodiment, the bottom surface of the pedal includes a generally flat, textured surface suitable for use with normal, non-clipless shoes.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 illustrates a side view of a bike with barefoot pedals according to the present invention.

FIG. 2 illustrates a side perspective view of a right-side barefoot pedal according to the present invention.

FIG. 3 illustrates a side perspective view of a left-side barefoot pedal according to the present invention.

FIG. 4 illustrates a side perspective view of a barefoot pedal according to the present invention.

FIG. 5 illustrates a side view of a barefoot pedal according to the present invention.

FIG. 6 illustrates a side view of a barefoot pedal according to the present invention.

FIG. 7 illustrates a side view of a barefoot pedal according to the present invention.

FIG. 8 illustrates a side view of a barefoot pedal according to the present invention.

FIG. 9 illustrates a side view of a barefoot pedal according to the present invention.

FIG. 10 illustrates a side view of a barefoot pedal according to the present invention.

FIG. 11 illustrates a bottom view of a barefoot pedal according to the present invention.

FIG. 12 illustrates a bottom perspective view of a barefoot pedal according to the present invention.

FIG. 13 illustrates an axle and bearing mechanism of a barefoot pedal according to the present invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

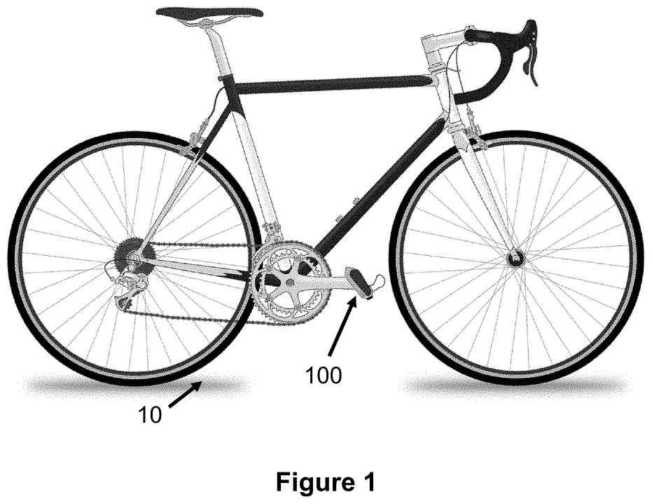

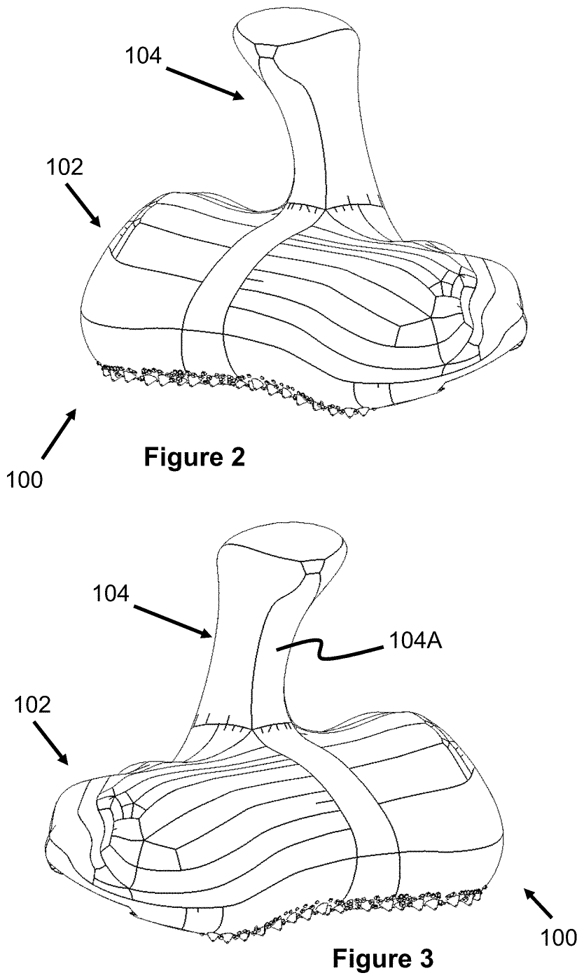

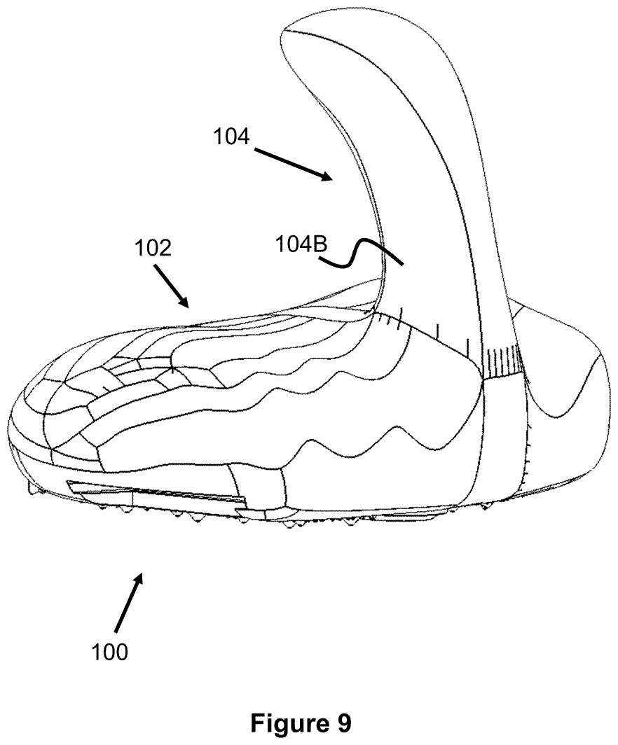

The present invention is generally directed to a pedal for bicycles, tandem bicycles, tricycles, or similar foot-powered vehicles that is configured for use with a bare foot or alternately with a shoe that provides at least some separation between a user's toes (e.g., toe shoes such as Vibram Five Fingers shoes). While the term “bike” is used in this specification, it should be understood to mean bicycles, tandem bicycles, tricycles, or any similar foot-powered vehicles. FIG. 1 illustrates an example embodiment of a bicycle 10 that includes two barefoot pedals 100 on each side of the bike's crankset. Various views of the pedal can be seen best in FIGS. 2-12, as described detail below.

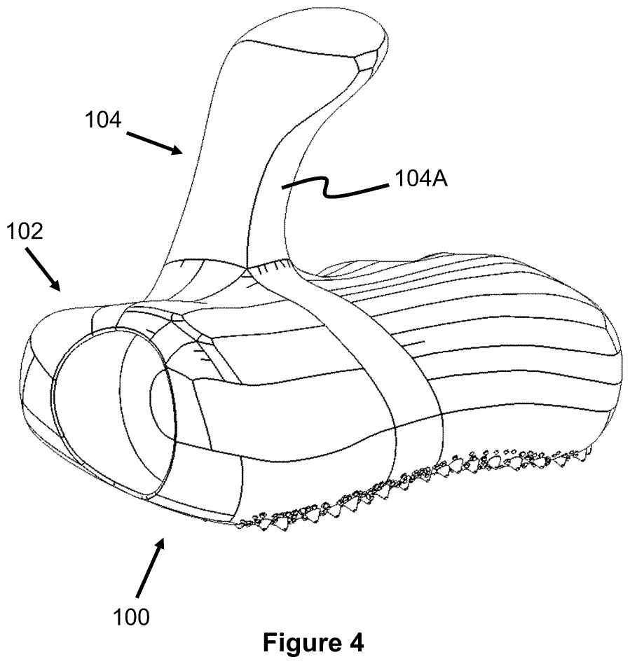

The barefoot pedal 100 generally includes a platform portion 102 that supports an underside of the user's foot and a toe post 104 that engages the user's foot between the first, largest toe and user's second, “long” toe. FIG. 2 illustrates a “right” foot barefoot pedal 100 (i.e., for use on the right side of a bike) while FIG. 3 illustrates a “left” foot barefoot pedal 100 (i.e., for use on the left side of a bike). While FIGS. 4-12 illustrate only the “right” foot barefoot pedal 100, it should be understood that these features are mirrored on the “left” foot barefoot pedal 100 as well.

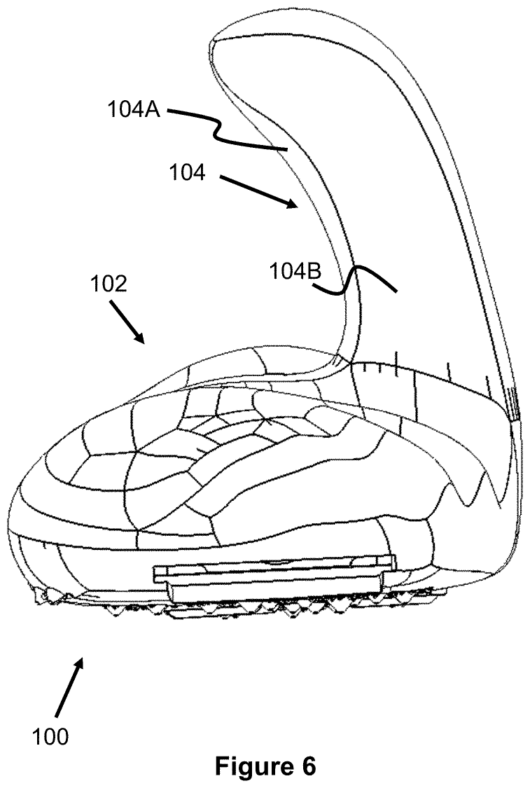

The toe post 104 preferably extends upward or perpendicular from a front portion of the platform 102 to a height that is generally taller than the front portion of a user's foot. For example, the toe post 104 may have a height relative to the platform 102 between about 1.5 inches to about 3.5 inches, and more preferably about 2 inches. As seen best in FIGS. 6-8, both sides 104B and the rearward surface 104A have concave or inwardly curved surfaces, resulting in the post 104 having a lower width of, for example, about ⅝ inches (0.625 in), a middle width of about ⅜ inches (0.375 in), and an upper width of about ⅞ inches (0.875 in). In another example, the front-to-back length of the toe post is, for example, about ⅞ inches (0.875 in) at its lower portion, ⅝ inches (0.625 in) at its middle portion, and about 1 inch at its top portion. In another example, the toe post 104 is positioned at about 1 and ⅝ inches (1.625 in) from the left edge of the right pedal and at about 2 inches from the right edge of the right pedal. This curved shape helps ergonomically fit between the user's two front toes and prevent the toes from slipping upward and off the toe post 104.

Preferably, the toe post 104 is free from connection to any additional components at its top surface to allow for easier engagement with the user's toes. However, an alternate embodiment may include a connection point at the top of the toe post 104 for straps or similar foot retention structures.

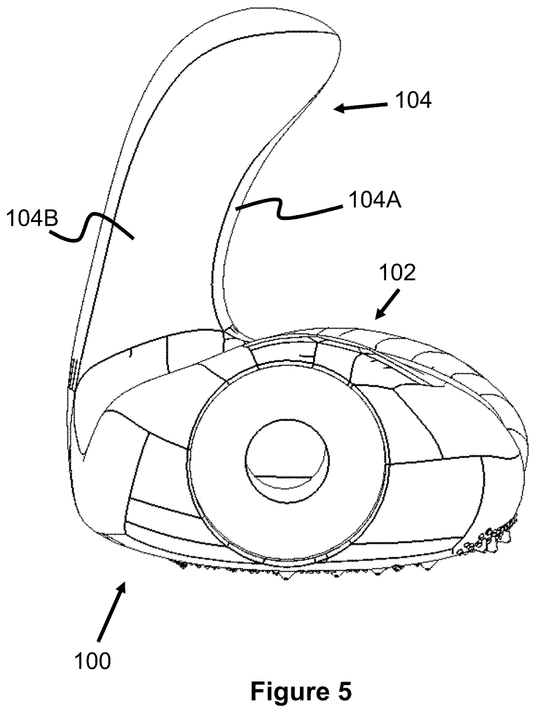

The platform portion 102 is preferably sized and contoured to accommodate the width of a user's foot. For example, the width of the foot portion 102 is between about 2.5 inches and 4.5 inches, and is preferably about 3.5 inches. In another example, the front-to-back length of the platform portion 102 is between about 1.5 inches to 3.5 inches, and preferably about 2.5 inches. As best seen in FIGS. 5 and 6, the surface of the platform portion 102 is rounded between its front and back edges. For example, the top surface of the platform portion 102 may have a curve of about 85 degrees.

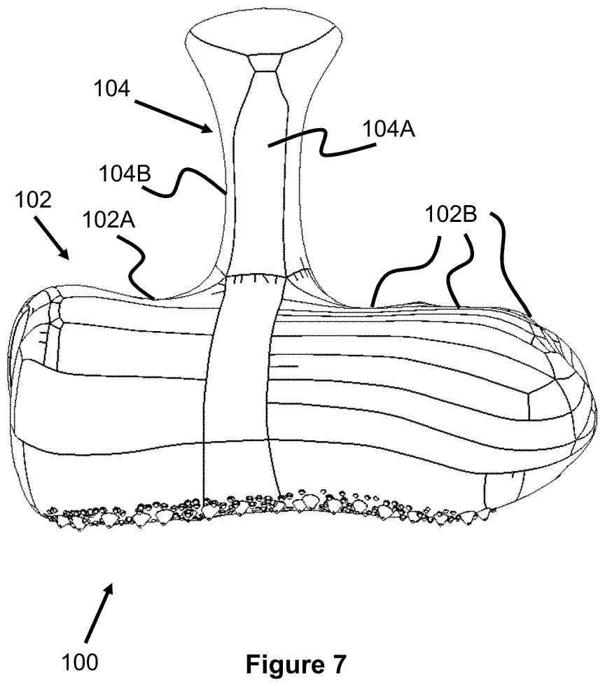

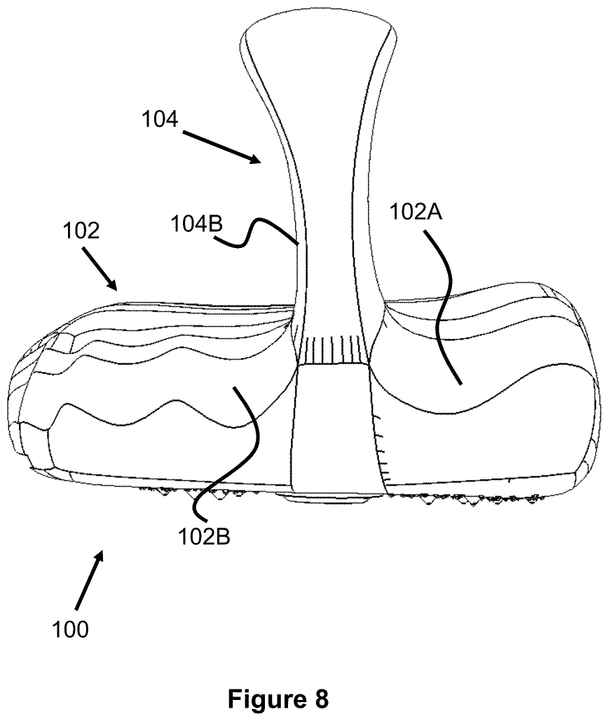

As seen best in FIGS. 7 and 8, the platform portion 102 may also include curves along portions of its width to better accommodate user's foot and/or toes. For example, the platform portion 102 may include a depression or downward curve 102A between the toe post 104 and the left edge of the pedal, as seen in FIG. 7. In another example, the platform portion 102 may include one or more depressions between the toe post 104 and the right edge of the pedal, as seen in FIG. 7, to accommodate the second, third, fourth, and fifth toe.

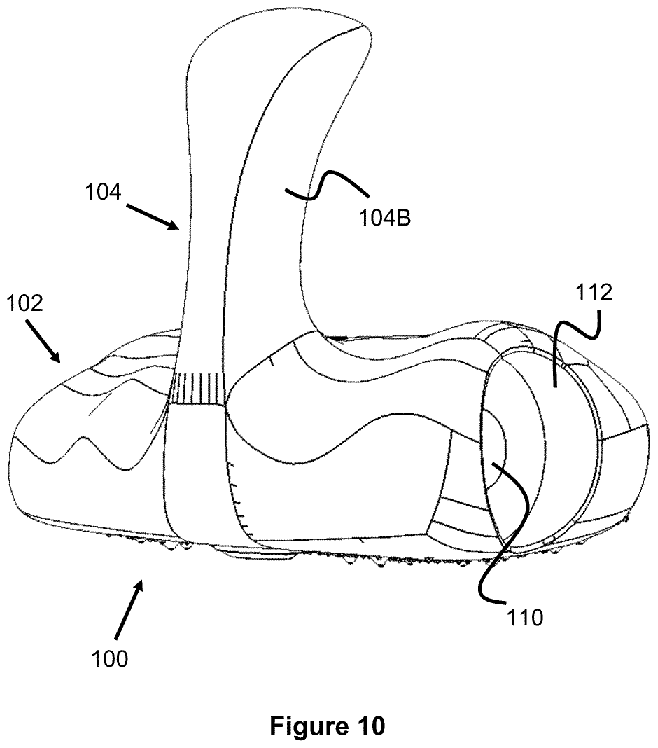

The barefoot pedal 100 is connected to the crankset of a bike via a pedal axle 106 (FIG. 13) that allows the pedal to rotate relative to the crankset. As seen best in FIGS. 10-12, the pedal 100 includes a tubular passage 110 that is sized to accommodate the pedal axle 106. An inner side of the pedal 100 includes a recessed area 112 around the inner side aperture of the passage 110, which accommodates the connection mechanism to the crankset. A second recessed area 114 is open at the bottom of the pedal 100, near its outer end, which allows access a wrench or similar tool access to a nut or similar mechanism on the end of the axle 106 so that the pedal 100 can be easily connected or removed. While the second recessed area 114 is open at the bottom of the pedal 100, in an alternate embodiment it can be positioned and open on the outer side of the pedal 100.

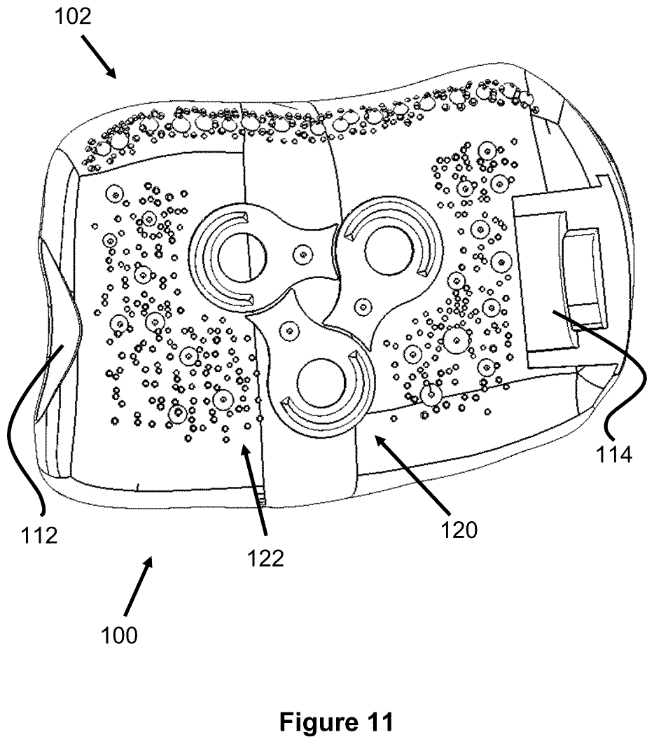

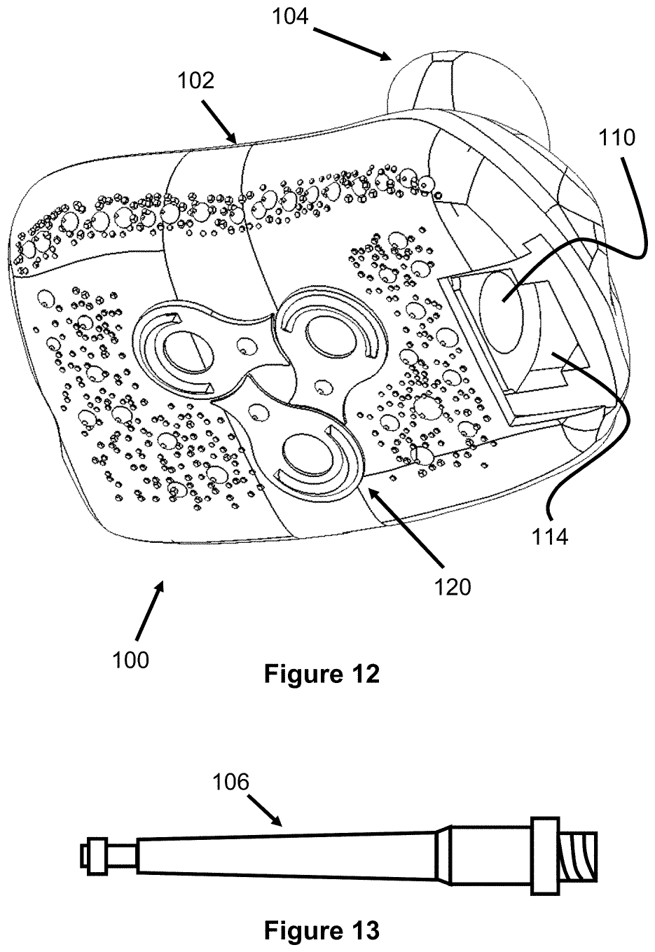

The barefoot pedal 100 may also include a bottom surface, seen in FIGS. 11 and 12, having a clipless engagement mechanism 120 that engages a portion of a user's shoes. A variety of different clipless engagement mechanisms are known in the art and can be used on the bottom surface of the pedal 100. This allows the user to easily use bare feet to pedal their bike or clipless shoes. The bottom surface may also include a plurality of raised bumps 122 that provide grip/traction should the user alternately want to use normal or non-clipless shoes for riding.

In operation, the user may first attach the left and right barefoot pedals 100 to a crankset of a bike with axle 106. Next, the user places their first toe on an inner side of the toe post 104 and the remaining toes on the outer side of the toe post 104 and begins pedaling.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof. While the term “about” may be used in this specification relative to measurements, it should be understood to me a plus/minus variance with 5%.

What is claimed is:

1. One or more pedals for a bike, each of which comprising:
a platform portion configured to rotatably connect to a crankset of a bike; and,
a toe post extending from a front area of the platform portion; said toe post extending away from a top surface of the platform portion;
wherein said platform portion and said toe post are both contoured to support a bare human foot.

2. The one or more pedals of claim 1, wherein the toe post has inwardly curved side surfaces.

3. The one or more pedals of claim 1, wherein the toe post has an inwardly curved rearward surface.

4. The one or more pedals of claim 1, wherein a top surface of the platform portion is rounded downwardly along its outer edges.

5. The one or more pedals of claim 1, wherein the toe post has a height relative to a top of the platform portion between about 1.5 inches to about 3.5 inches.

6. The one or more pedals of claim 1, wherein the toe post has a width within a range of about 0.6 inches to 0.9 inches.

7. The one or more pedals of claim 1, wherein the toe post has a front-to-back length within a range of about 0.6 inches to 0.9 inches.

8. The one or more pedals of claim 1, wherein a top of the toe post is exposed and free from connection to additional structures beyond the platform portion.

9. The one or more pedals of claim 1, further comprising a clipless attachment mechanism located on a bottom surface of the platform portion.

10. The one or more pedals of claim 1, further comprising an axle passage extending laterally through a portion of the platform portion; the axle portion terminating in an outer recessed area that is open at a bottom surface of the platform portion.

11. A bike having a set of attached pedals, the pedals comprising:
a platform portion configured to rotatably connect to a crankset of a bike; and,
a toe post extending from a front area of the platform portion; said toe post extending away from a top surface of the platform portion;
wherein said platform portion and said toe post are both contoured to support a bare human foot.

12. The one or more pedals of claim 11, wherein the toe post has inwardly curved side surfaces.

13. The one or more pedals of claim 12, wherein the toe post has an inwardly curved rearward surface.

14. The one or more pedals of claim 13, wherein the top surface of the platform portion is rounded downwardly along its outer edges.

15. The one or more pedals of claim 14, wherein the toe post has a height relative to a top of the platform portion between about 1.5 inches to about 3.5 inches.

16. The one or more pedals of claim 15, wherein the toe post has a width within a range of about 0.6 inches to 0.9 inches.

17. The one or more pedals of claim 16, wherein the toe post has a front-to-back length within a range of about 0.6 inches to 0.9 inches.

18. The one or more pedals of claim 17, further comprising a clipless attachment mechanism located on a bottom surface of the platform portion.

19. One or more pedals for a bike, each of which comprising:
a platform portion configured to rotatably connect to a crankset of a bike; a top surface of the platform portion being downwardly rounded along its outer edges; and,
a toe post extending from a front area of the platform portion; said toe post extending away from a top surface of the platform portion, having inwardly curved side surfaces, and having an inwardly curved rearward surface;
wherein said platform portion and said toe post are both contoured to support a bare human foot.
